(19) United States
(12) Patent Application Publication
(10) Pub. No.: US 2026/0014690 A1
(43) Pub. Date: Jan. 15, 2026

(54) SUPPORT, SUPPORT DEVICE AND SAWHORSE

(71) Applicant: HANGZHOU GREAT STAR INDUSTRIAL CO., LTD., Hangzhou (CN)

(72) Inventor: Feng LI, Hangzhou (CN)

(21) Appl. No.: 19/335,340

(22) Filed: Sep. 22, 2025

Related U.S. Application Data
(63) Continuation of application No. PCT/CN2023/087050, filed on Apr. 7, 2023.

(51) Int. Cl. B25H 1/10; B25H 1/06; B27B 17/00

(52) U.S. Cl. CPC B25H 1/10; B25H 1/06; B27B 17/0041

(57) ABSTRACT

The present application relates to a support, a support device and a sawhorse. The support includes a fixed assembly, a sliding assembly and a limiting assembly, the sliding assembly cooperates with the fixed assembly to clamp a wood, and the sliding assembly is slidable relative to the fixed assembly to clamp the wood with different sizes. The limiting assembly is disposed on the fixed assembly and the sliding assembly, and is configured to lock or unlock the sliding of the sliding assembly relative to the fixed assembly.

### CROSS-REFERENCE TO RELATED APPLICATION

This application is a continuation of international patent application No. PCT/CN2023/087050, filed on Apr. 7, 2023. The content of the above identified application is hereby incorporated herein in its entirety by reference.

### TECHNICAL FIELD

The present disclosure relates to the field of support technology, and in particular, to a support, a support device, and a sawhorse.

### BACKGROUND

During woodworking, a sawhorse is usually used to support wood, and supports are added at both ends of the sawhorse for convenience of operation.

In existing sawhorses, the widths of the supports at both ends of the sawhorse stool are usually fixed and unchanged, which cannot be applied to woods with different sizes, and the stability of supporting woods is poor. At the same time, some sawhorses cannot adjust the height, and thus cannot adapt to different operation heights, which is inconvenient to operate. In some sawhorses, although a foot rod is configured as a liftable structure, the lifting structure is usually configured as an elastic structure, the lifting structure has poor stability, the foot rod may shake, or the sawhorses tilt easily during operation.

### SUMMARY

According to various embodiments of the present disclosure, a support, a support device, and a sawhorse are provided.

The present disclosure first provides a support for fixing a wood, including: a fixed assembly; a sliding assembly cooperating with the fixed assembly to clamp the wood, the sliding assembly being configured to slide relative to the fixed assembly to clamp woods with different sizes; and a limiting assembly disposed on the fixed assembly and/or the sliding assembly and configured to lock or unlock sliding of the sliding assembly relative to the fixed assembly.

In an embodiment, the sliding assembly includes a sliding member and a clamping member disposed at one end of the sliding member. The fixed assembly is provided with a sliding groove. One end of the sliding member away from the clamping member is configured to slidably extend into the sliding groove to adjust a distance between the clamping member and the fixed assembly when the sliding member slides relative to the fixed assembly.

In an embodiment, the limiting assembly includes a limiting member. The sliding member is provided with a plurality of limiting holes arranged at intervals along a sliding direction of the sliding member. The fixed assembly is correspondingly provided with a through hole. The limiting member is configured to pass through the through hole and any one of the plurality of limiting holes to lock the sliding assembly to slide relative to the fixed assembly at different positions.

In an embodiment, the sliding member includes a first sliding portion and a second sliding portion arranged at intervals along a penetrating direction of the limiting member. The first sliding portion is provided with an avoidance groove extending along a sliding direction of the sliding assembly. The plurality of limiting holes are located on the second sliding portion. The limiting member is configured to sequentially pass through the avoidance hole and any one of the plurality of limiting holes from a side of the first sliding portion away from the second sliding portion.

In an embodiment, an abutting portion protrudes from an outer periphery of the limiting member. The limiting assembly further includes an elastic member disposed between the abutting portion and a side wall of the sliding groove. The elastic member is configured to apply an elastic force toward the limiting hole to the limiting member.

In an embodiment, the limiting assembly includes a first cam disposed on the fixed assembly. An avoidance hole is provided on a side wall of the sliding groove corresponding to the first cam. The first cam is rotatable relative to the fixed assembly and is configured to push the sliding member at the avoidance hole, so that the sliding member is configured to abut against a side wall of the sliding groove opposite to the avoidance hole.

In an embodiment, the limiting assembly further includes a first handle extending from the first cam along a radial direction of the first cam.

In an embodiment, the support further includes a guide member disposed on one of the fixed assembly and the sliding assembly, the other of the fixed assembly and the sliding assembly is provided with a guide groove extending along a sliding direction of the sliding assembly. The guide member is slidably disposed in the guide groove.

The present disclosure further provides a support device for supporting a support, including: a support assembly; a lifting assembly, connected to the support and configured to lift relative to the support assembly along a length direction of the support assembly to drive the support to rise and fall; and a locking assembly, arranged on the support assembly and/or the lifting assembly and configured to lock or unlock the lifting assembly relative to the support assembly.

In an embodiment, the locking assembly includes a locking member arranged on one of the support assembly and the lifting assembly, and the other of the support assembly and the lifting assembly is provided with a plurality of locking elements arranged at intervals along a sliding direction of the lifting assembly. The locking member is configured to cooperate with any one of the plurality of locking elements to lock the sliding of the lifting assembly relative to the support assembly at different positions.

In an embodiment, the locking member is pivotally connected to the support assembly and is configured to be rotatably inserted into/disengaged from the plurality of locking elements to lock or unlock lifting of the lifting assembly relative to the support assembly.

In an embodiment, the locking assembly further includes a rotating shaft and a torsion spring. The locking member is capable of rotating relative to the support assembly through the rotating shaft. Two torsion arms of the torsion spring are respectively limited on the rotating shaft and the support assembly.

In an embodiment, the locking member includes an insertion portion configured to be inserted into the locking element. The plurality of locking elements are configured as insertion holes. When the lifting assembly rises relative to the supporting assembly, an inner wall of the insertion hole is configured to push against the insertion portion, so that the insertion portion is disengaged from the insertion holes.

In an embodiment, the insertion portion is configured as a protrusion or a hook.

In an embodiment, the locking assembly further includes a second cam disposed on the locking member and configured to rotate synchronously with the locking member, and the second cam abuts against the lifting assembly when the insertion portion is inserted into the insertion holes.

In an embodiment, the locking assembly further includes a second handle extending from the second cam along a radial direction of the second cam.

In an embodiment, the locking assembly further includes a gasket disposed on the support assembly, the gasket is located between the second cam and the lifting assembly, and the second cam can abut against the lifting assembly through the gasket.

The present disclosure further provides a sawhorse, including the support and the supporting device, and the lifting assembly is supported at a bottom of the fixed assembly.

In an embodiment, the fixed assembly is provided with an accommodating cavity with an opening facing the support device, and the support device is rotatable relative to the fixed assembly into the accommodating cavity.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

In order to better describe and illustrate embodiments and/or examples of those inventions disclosed herein, reference may be made to one or more drawings. The additional details or examples used to describe the figures should not be taken as limiting the scope of any of the disclosed inventions, the presently described embodiments and/or examples, and the presently understood best mode of these inventions.

FIG. 1 is a perspective view of a sawhorse according to one or more embodiments.

FIG. 2 is a partial view of a support in FIG. 1.

FIG. 3 is a schematic diagram of cooperation between a sliding assembly and a limiting assembly in FIG. 2.

FIG. 4 is another schematic diagram of cooperation between a sliding assembly and a limiting assembly in FIG. 3.

FIG. 5 is a partial view of a support device in FIG. 1.

FIG. 6 is an enlarged view of A portion of the support device in the first embodiment in FIG. 5.

FIG. 7 is a sectional view of A portion of the support device in FIG. 6.

FIG. 8 is an enlarged view of A portion of the support device in a second embodiment of FIG. 6.

FIG. 9 is a sectional view of A portion of the support device in FIG. 8.

FIG. 10 is an enlarged view of A portion of the support device in a third embodiment of FIG. 6.

FIG. 11 is a sectional view of A portion of the support device in FIG. 10.

FIG. 12 is a perspective view of the sawhorse of FIG. 1 in a rotated state.

### DETAILED DESCRIPTION

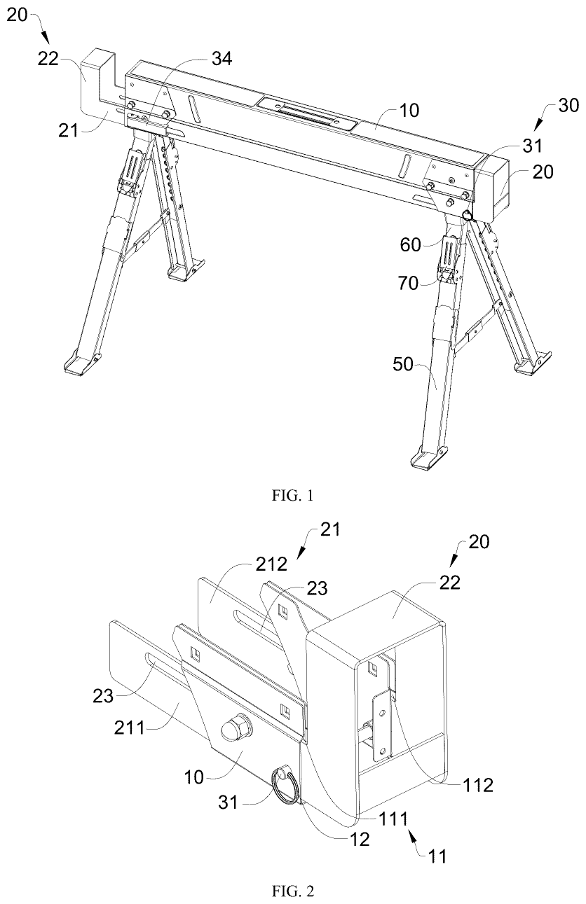

As shown in FIG. 1, the present disclosure first provides a support for fixing wood. The support includes a fixed assembly 10, a sliding assembly 20 and a limiting assembly 30. The sliding assembly 20 cooperates with the fixed assembly 10 to clamp the wood. The sliding assembly 20 is configured to slide relative to the fixed assembly 10 to clamp the wood with different sizes. The limiting assembly 30 is disposed on the fixed assembly 10 and the sliding assembly 20. The limiting assembly 30 is configured to lock or unlock sliding of the sliding assembly 20 relative to the fixed assembly 10.

The present disclosure includes the following advantages: the sliding assembly 20 can slide relative to the fixed assembly 10 to adjust a distance between the sliding assembly 20 and the fixed assembly 10 in a sliding direction of the sliding assembly 20, so that the support can clamp wood with different sizes, and multiple sawhorses with different sizes are not required any more, thereby reducing processing cost of the wood. When the position of the sliding assembly 20 needs to be adjusted, the user can control the limiting assembly 30 to unlock, so that the sliding assembly 20 can slide relative to the fixed assembly 10. When the sliding assembly 20 slides until the distance between the sliding assembly 20 and the fixed assembly 10 matches a width of the wood to be clamped, the user can control the limiting assembly 30 to lock the sliding of the sliding assembly 20 relative to the fixed assembly 10. At this time, the sliding assembly 20 cannot slide relative to the fixed assembly 10, thereby ensuring the stability of clamping the wood, preventing the wood from tilting or falling during processing, and ensuring the processing accuracy and processing efficiency.

In the illustrated embodiment, there are two sliding assemblies 20, and the two sliding assemblies 20 are respectively disposed at two ends of the fixed assembly 10. Of course, in other embodiments, the number of the sliding assembly 20 may also be one, three or more, as long as it can cooperate with the fixed assembly 10 to clamp the wood, which is not specifically limited herein.

As shown in FIG. 1 to FIG. 2, in an implementation, the sliding assembly 20 includes a sliding member 21 and a clamping member 22 disposed at one end of the sliding member 21. The fixed assembly 10 is provided with a sliding groove 11. One end of the sliding member 21 away from the clamping member 22 is configured to slidably extend into the sliding groove 11. When the sliding member 21 slides relative to the fixed assembly 10, the sliding member 21 is configured to drive the clamping member 22 to slide relative to the fixed assembly 10, so as to adjust the distance between the clamping member 22 and the fixed assembly 10 in a sliding direction of the sliding member 21. The sliding member 21 is configured to slidably extend and retract in the sliding groove 11, and drive the clamping member 22 to slide relative to the fixed assembly 10 outside the sliding groove 11, thereby adjusting the distance between the clamping member 22 and the fixed assembly 10, so that woods of different sizes can be clamped between the clamping member 22 and the fixed assembly 10. The sliding groove 11 can limit the sliding direction of the sliding member 21 and improve the stability of the sliding member 21 and the clamping member 22, and after the wood is placed between the clamping member 22 and the fixed assembly 10, the sliding member 21 can also support the wood at the bottom of the wood, further improving the stability of clamping the wood.

In another embodiment, an extension portion may extend from one end of the fixed assembly 10 in the sliding direction of the sliding assembly 20, and the sliding assembly 20 is slidably disposed on the extension portion to adjust the distance between the sliding assembly 20 and the fixed assembly 10, and the extension portion is also configured to support the wood.

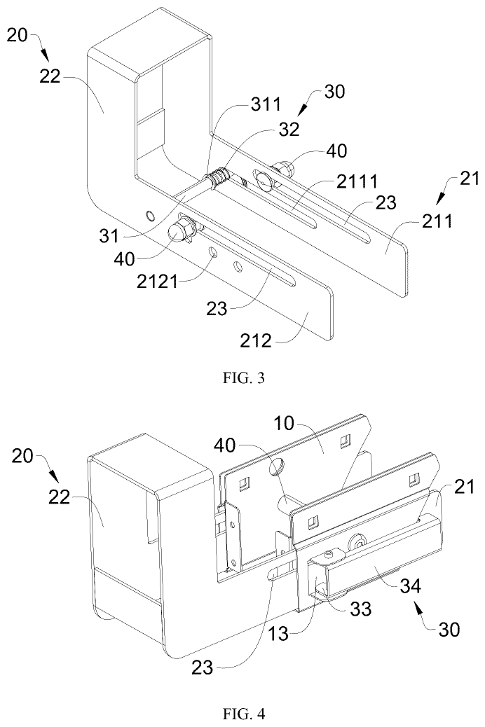

As shown in FIG. 2 to FIG. 3, in an embodiment, the limiting assembly 30 includes a limiting member 31. The sliding member 21 is provided with a plurality of limiting holes 2121 arranged at intervals along a sliding direction of the sliding member 21. The fixed assembly 10 is correspondingly provided with through holes 12, and the limiting member 31 can pass through the through holes 12 and any one of the plurality of limiting holes 2121 to restrict the sliding assembly 20 from sliding relative to the fixed assembly 10 at different positions. Since the size of the processed wood is mostly a standard size, the plurality of limiting holes 2121 can be provided according to the wood with multiple sizes in the sliding direction of the sliding member 21. When the wood needs to be clamped, it is only necessary to pass the limiting member 31 through the through holes 12 and the plurality of limiting holes 2121 corresponding to the size of the wood, without measuring the distance between the sliding member 21 and the fixed assembly 10, and the operation is simple and convenient.

A size of each of the through holes 12 and a size of each of the plurality of limiting holes 2121 are both equal to or slightly greater than a size of the limiting member 31, so that the limiting member 31 can be inserted into or disengage from the through holes 12 and the limiting holes 2121 while preventing the limiting member 31 from shaking in the through holes 12 and the limiting holes 2121 to affect the stability between the sliding assembly 20 and the fixed assembly 10.

Referring to FIG. 3, the sliding member 21 includes a first sliding portion 211 and a second sliding portion 212 arranged at intervals along a penetrating direction of the limiting member 31. The first sliding portion 211 is provided with an avoidance groove 2111 extending along a sliding direction of the sliding assembly 20. The second sliding portion 212 is provided with a limiting hole 2121. The limiting member 31 can sequentially pass through the avoidance hole 13 and any one of the plurality of limiting holes 2121 from a side of the first sliding portion 211 away from the second sliding portion 212. The limiting holes 2121 being located in the second sliding portion 212 can ensure the stability of the limiting member 31 when cooperating with the limiting holes 2121, and prevent the limiting member 31 from easily falling off due to an excessively short distance by which the limiting member 31 is inserted into the fixed assembly 10 and the sliding assembly 20. Moreover, when the sliding assembly 20 is adjusted, the sliding assembly 20 can be controlled to slide relative to the fixed assembly 10 only by controlling the limiting member 31 to disengage from the limiting hole 2121. At the same time, the avoidance hole 13 can also prevent the sliding assembly 20 from interfering with the limiting member 31 during the sliding process, so that the limiting member 31 can be prevented from being lost due to the limiting member 31 being completely separated from the sliding assembly 20 and the fixed assembly 10, or the limiting member 31 needs to be aligned with the through holes 12 on the fixed assembly 10 again, thereby simplifying the adjustment steps. Of course, the sliding member 21 may also be provided with only the limiting hole 2121, and when the sliding assembly 20 needs to be adjusted, the limiting member 31 is controlled to completely exit the sliding assembly 20 and the fixed assembly 10.

In the illustrated embodiment, the fixed assembly 10 is provided with a first groove 111 and a second groove 112 respectively corresponding to the first sliding portion 211 and the second sliding portion 212. The first groove 111 and the second groove 112 can respectively limit the sliding directions of the first sliding portion 211 and the second sliding portion 212, thereby improving the stability of the sliding assembly 20 when sliding relative to the fixed assembly 10. Two side walls of the first groove 111 are provided with opposite through holes 12, and a side wall of the second groove 112 facing the first sliding portion 211 is provided with a through hole 12, so that the limiting member 31 can sequentially pass through the through hole 12 of the first groove 111 away from the second sliding portion 212, the avoidance groove 2111, the through hole 12 of the first groove 111 facing the second sliding portion 212, the through hole 12 of the second groove 112 facing the first sliding portion 211, and the limiting hole 2121.

Of course, in other embodiments, the fixed assembly 10 may also be provided with only one sliding groove 11. The first sliding portion 211 and the second sliding portion 212 are both slidably disposed in the sliding groove 11. A through hole 12 is provided on a side wall of the sliding groove 11 away from the second sliding portion 212. The limiting member 31 can sequentially pass through the through hole 12, the avoidance groove 2111 and the limiting hole 2121.

Referring to FIG. 3, an abutting portion 311 protrudes from an outer periphery of the limiting member 31. The limiting assembly 30 further includes an elastic member 32 disposed between the abutting portion 311 and a side wall of the sliding groove 11. The elastic member 32 can apply an elastic force toward the limiting hole 2121 to the limiting member 31. When the limiting member 31 is controlled to disengage from the limiting hole 2121, the elastic member 32 is elastically deformed and stores elastic potential energy. When the adjustment is completed and the external force applied to the limiting member 31 is withdrawn, the elastic potential energy of the elastic member 32 is released and an elastic force towards the limiting hole 2121 is applied to the limiting member 31, and the limiting member 31 can be inserted into the limiting hole 2121 again under the action of the elastic force. In addition, when the limiting member 31 is inserted into the limiting hole 2121, the elastic member 32 may also apply an elastic force toward the limiting hole 2121 to the limiting member 31, to improve stability of cooperation between the limiting member 31 and the limiting hole 2121, and prevent the limiting member 31 from accidentally disengaging from the limiting hole 2121.

The abutting portion 311 may be located between the first sliding portion 211 and the second sliding portion 212, and the abutting portion 311 can prevent the limiting member 31 from completely disengaging from the sliding assembly 20. The elastic member 32 may be configured as a compression spring. The spring is sleeved on the limiting member 31. Two ends of the spring respectively abut against the abutting portion 311 and the outer side wall of the first groove 111 facing the second sliding portion 212. Alternatively, the elastic member 32 can be an elastic element such as a tension spring, a rubber member, or a silicone member, which is not specifically limited in this embodiment of the present disclosure.

Referring to FIG. 4, in another embodiment, the limiting assembly 30 includes a first cam 33 arranged on the fixed assembly 10. A side wall of the sliding groove 11 corresponding to the first cam 33 is provided with an avoidance hole 13. The first cam 33 is rotatable relative to the fixed assembly 10 and can push the sliding member 21 at the avoidance hole 13, so that the sliding member 21 abuts against a side wall of the sliding groove 11 opposite to the avoidance hole 13. The first cam 33 is configured as a disc cam. The disc cam is further configured as a disc member that can rotate around a fixed axis and has a variable diameter. When the first cam 33 rotates to a position with a smaller diameter facing the avoidance hole 13, the first cam 33 is not in contact with the sliding member 21, and does not limit the sliding member 21 to slide in the sliding groove 11. When the first cam 33 rotates to a position with a larger diameter facing the avoidance hole 13, the first cam 33 is in contact with the sliding member 21, and pushes the sliding member 21 to side away from the first cam 33, so that the sliding member 21 abuts against an inner wall of a side of the sliding groove 11 away from the first cam 33, to limit the sliding member 21 from sliding in the sliding groove 11. This adjustment mode is stepless adjustment, even if a size of the processed wood is not in a standard size, the user can adjust a distance between the clamping member 22 and the fixed assembly 10 as required, and all sizes of wood within a limit range of adjustment can be applied to the support, so that the compatibility of the support can be expanded.

Referring to FIG. 4, the limiting assembly 30 further includes a first handle 34 extending from the first cam 33 along a radial direction of the first cam 33. The user can drive the first cam 33 to rotate by controlling the first handle 34, so that the first handle 34 can facilitate the user to control and rotate the first cam 33, which is convenient and labor-saving.

Referring to FIG. 3 to FIG. 4, the support further includes a guide member 40 disposed on one of the fixed assembly 10 and the sliding assembly 20, the other of the fixed assembly 10 and the sliding assembly 20 is provided with a guide groove 23 extending along the sliding direction of the sliding assembly 20. The guide member 40 is slidably disposed in the guide groove 23. The cooperation of the guide member 40 and the guide groove 23 can limit the sliding direction of the sliding assembly 20, and ensure that the sliding assembly 20 always slides along the extension direction of the guide groove 23, thereby improving the stability of the sliding assembly 20 when sliding relative to the fixed assembly 10.

Referring to FIG. 3, in one embodiment, the number of the guide members 40 is two, the two guide members 40 are respectively fixed to the side wall of the first groove 111 and the side wall of the second groove 112. The first sliding portion 211 and the second sliding portion 212 are respectively provided with guide grooves 23, and each of the two guide members 40 is correspondingly in sliding fit with one guide groove 23. Referring to FIG. 4, in another embodiment, there is one guide member 40. Two ends of the guide member 40 are respectively fixed to the side walls of the first groove 111 and the second groove 112. The first sliding portion 211 and the second sliding portion 212 are respectively provided with guide grooves 23, and two ends of the guide member 40 are respectively in sliding fit with one guide groove 23.

Of course, in other embodiments, only one guide member 40 may be provided to cooperate with one guide groove 23, as long as the sliding direction of the sliding assembly 20 can be limited, which is not specifically limited in the embodiments of the present disclosure.

In the conventional technology, some sawhorses cannot adjust the height, and thus cannot adapt to different operation heights, which is inconvenient to operate. Although a foot rod of some sawhorses is configured as a liftable structure, the liftable structure is usually formed by sleeving an inner foot rod and an outer foot rod and matching an elastic buckle with a positioning hole. The elastic buckle type liftable structure has poor stability. The foot rod tends to shake, or it is prone to cause the sawhorse to tilt during operation.

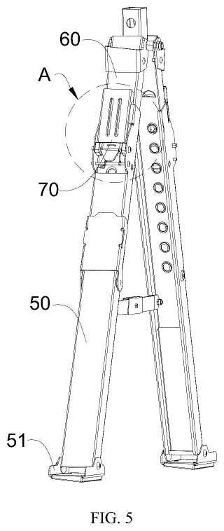

Referring to FIG. 5, the present disclosure further provides a support device for supporting a support, including a support assembly 50, a lifting assembly 60 and a locking assembly 70. The lifting assembly 60 is connected to the support and can lift relative to the support assembly 50 along a length direction of the support assembly 50 to drive the support to lift. The locking assembly 70 is arranged on the support assembly 50 and the lifting assembly 60 and is configured to lock or unlock the lifting assembly 60 relative to the support assembly 50.

The support assembly 50 can be placed at an external operation position such as a tabletop or the ground. The support is connected to the lifting assembly 60. When the height of the support needs to be adjusted, the user can control the locking assembly 70 to unlock, at this time, the lifting assembly 60 can lift relative to the support assembly 50 along the length direction of the support assembly 50. The lifting assembly 60 can drive the support to synchronously lift relative to the support assembly 50, so that the height of the support can be adjusted. Thus, the support can adapt to different working heights. After the adjustment is completed, the user can control the locking assembly 70 to lock the lifting assembly 60 to lift relative to the support assembly 50. At this time, the lifting assembly 60 cannot lift relative to the support assembly 50, so that the stability of the support of the support device can be ensured, and the support can be prevented from shaking or tilting during the process of processing woods.

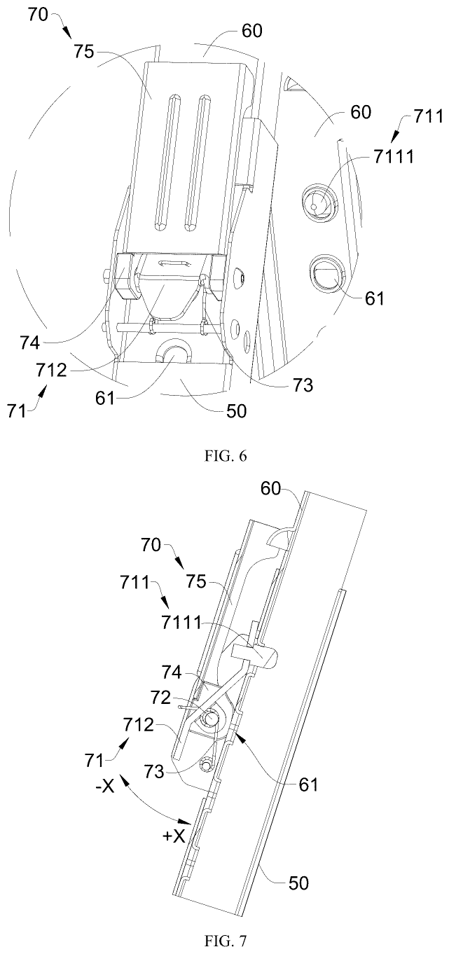

Referring to FIG. 6, the support assembly 50 is sleeved outside the lifting assembly 60. The lifting assembly 60 is configured to slide in the support assembly 50 along the length direction of the support assembly 50 to achieve lifting. The side wall of the support assembly 50 is provided with an avoidance opening 52. The locking assembly 70 is arranged at a position where the support assembly 50 is provided with the avoidance opening 52, and cooperates with the lifting assembly 60 through the avoidance opening 52 to lock or unlock the lifting assembly 60 relative to the support assembly 50.

Referring to FIGS. 6 to 7, the locking assembly 70 includes a locking member 71 arranged on one of the support assembly 50 and the lifting assembly 60, and the other of the support assembly 50 and the lifting assembly 60 is provided with a plurality of locking elements 61 arranged at intervals along the sliding direction of the lifting assembly 60. The locking member 71 can cooperate with any one of the plurality of locking elements 61 to lock the sliding of the lifting assembly 60 relative to the support assembly 50 at different positions. After the lifting assembly 60 is controlled to slide to a required height relative to the support assembly 50, it is only necessary to control the locking member 71 to cooperate with the corresponding locking element 61 to limit the lifting of the lifting assembly 60 relative to the support assembly 50, which is simple and convenient to operate.

Referring to FIGS. 6 to 7, the locking member 71 is pivotally connected to the support assembly 50, and can be rotatably inserted into or disengaged from the locking element 61 to lock or unlock the lifting assembly 60 relative to the support assembly 50. When the lifting assembly 60 needs to be adjusted, the user can control the locking member 71 to rotate relative to the support assembly 50 and disengage from the locking element 61, so that the lifting assembly 60 can be lifted or lowered relative to the support assembly 50. After the adjustment is completed, the user controls the locking member 71 to rotate reversely relative to the support assembly 50 and insert into the locking element 61 again, so that the locking member 71 can cooperate with the locking element 61 to limit the lifting assembly 60 to be lifted or lowered relative to the support assembly 50. This adjustment manner is simple and convenient, and the locking member 71 is always connected to the support assembly 50 and is not easily lost.

Referring to FIG. 7, the locking assembly 70 further includes a rotating shaft 72 and a torsion spring 73. The locking member 71 is rotatable relative to the support assembly 50 via the rotating shaft. Two torsion arms of the torsion spring 73 are respectively limited on the rotating shaft 72 and the support assembly 50. When the locking member 71 is controlled to rotate out of the locking element 61, the rotating shaft 72 can rotate synchronously with the locking member 71, and the torsion spring 73 undergoes torsional elastic deformation and accumulates elastic potential energy. When the adjustment is completed and the external force applied to the locking member 71 is withdrawn, the elastic potential energy of the torsion spring is released, and the rotating shaft 72 will rotate reversely under the torsional elastic force of the torsion spring 73 and drive the locking member 71 to rotate reversely and insert into the locking element 61. In addition, when the locking member 71 is inserted into the locking element 61, the torsion spring 73 may also apply an elastic force to the rotating shaft 72, to improve stability of cooperation between the locking member 71 and the locking element 61, and prevent the locking member 71 from accidentally disengaging from the locking element 61.

Referring to FIGS. 6 to 7, the locking member 71 includes an insertion portion 711 configured to be inserted into the locking element 61. The locking element 61 is configured as an insertion hole. When the lifting assembly 60 rises relative to the support assembly 50, the inner wall of the insertion hole can abut against and push against the insertion portion 711, so that the insertion portion 711 is disengaged from the insertion hole. When the support needs to be lowered, the locking member 71 needs to be controlled to rotate relative to the support assembly 50 to disengage from the locking element 61 first, so that the lifting assembly 60 can be controlled to be lowered relative to the support assembly 50. When the support needs to be raised, the lifting assembly 60 can be directly pulled upward, and at this time, the inner wall of the insertion hole can push against the insertion portion 711, so that the insertion portion 711 overcomes the elastic force of the torsion spring 73 and rotates to disengage from the locking element 61, thereby simplifying the adjustment step when the lifting assembly 60 rises.

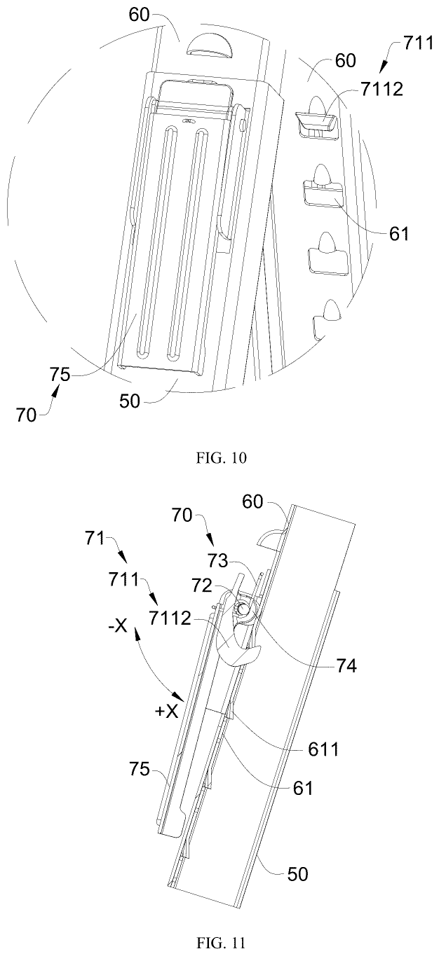

Referring to FIG. 6, FIG. 8 and FIG. 10, the insertion hole may be a regular or irregular hole-like structure such as a circular insertion hole or a rectangular insertion hole, as long as the insertion portion 711 can be inserted into the insertion hole to limit the lifting and lowering of the lifting assembly 60 relative to the support assembly 50, which is not specifically limited in the embodiments of the present disclosure.

Referring to FIG. 5, the bottom of the support assembly 50 is further provided with a support foot 51, and the user can step on the support foot 51 and pull up the lifting assembly 60 to prevent the support assembly 50 and the lifting assembly 60 from lifting synchronously, which is convenient for the user to operate.

Referring to FIG. 7, in an embodiment, the insertion portion 711 is provided as a protrusion 7111, the locking member 71 further includes a connecting portion 712 fixedly connected to the rotating shaft 72. The protrusion 7111 protrudes from a side surface of the connecting portion 712. The protrusion 7111 can ensure the stability of the insertion portion 711 when inserted into the insertion hole, thereby ensuring the stability of the locking assembly 70 in the locked state. When the connecting portion 712 rotates around the rotating shaft 72 in positive X direction, the protrusion 7111 is disengaged from the locking element 61. When the connecting portion 712 rotates around the rotating shaft 72 in negative X direction, the protrusion 7111 is inserted into the locking element 61. When the user pulls up the lifting assembly 60, an inner wall on the lower side of the insertion hole pushes upward against the protrusion 7111, so that the protrusion 7111 and the connecting portion 712 can rotate around the rotating shaft 72 in the positive X direction, and the protrusion 7111 is automatically disengaged from the insertion hole. When the user presses the lifting assembly 60 downward, an inner wall on the upper side of the insertion hole pushes the protrusion 7111 downward, the protrusion 7111 and the connecting portion 712 cannot rotate, and at this time, the protrusion 7111 can be disengaged from the insertion hole only by manually rotating the connecting portion 712.

As shown in FIGS. 10 to 11, in another embodiment, the insertion portion 711 is configured as a hook 7112, and the hook 7112 is directly fixedly connected to the rotating shaft 72. The hook 7112 can also ensure the stability of the insertion portion 711 when inserted into the insertion hole, thereby ensuring the stability of the locking assembly 70 in the locked state. When the hook 7112 rotates around the rotating shaft 72 in the negative X direction, the hook 7112 is disengaged from the locking element 61. When the hook 7112 rotates around the rotating shaft 72 in the positive X direction, the hook 7112 is inserted into the locking element 61. The upper side wall of the insertion hole is provided with an anti-disengagement portion 611, when the user presses down the lifting assembly 60, the anti-disengagement portion 611 will abut against an inner arc surface of the hook 7112 to limit the hook 7112 from rotating around the rotating shaft 72 to disengage from the insertion hole. At this time, only manually rotating the hook 7112 can make the hook 7112 being disengaged from the insertion hole. When the user lifts the lifting assembly 60 upward, the outer arc surface of the hook 7112 can abut against the inner wall on the lower side of the insertion hole, and under the action of the outer arc surface of the hook 7112, the hook 7112 can rotate around the rotating shaft 72 in the negative X direction, and the hook 7112 is automatically disengaged from the insertion hole.

Referring to FIGS. 6 to 7, the locking assembly 70 further includes a second cam 74. The second cam 74 is disposed on the locking member 71 and rotatable synchronously with the locking member 71. The second cam 74 can abut against the lifting assembly 60 when the insertion portion 711 is inserted into the insertion hole. The second cam 74 is configured as a disc cam. The disc cam is further configured as a disc member that can rotate around a fixed axis and has a variable diameter. When the insertion portion 711 is inserted into the insertion hole, the second cam 74 rotates to a position with a larger diameter toward the lifting assembly 60 and abuts against the lifting assembly 60, so as to prevent the insertion portion 711 from disengaging from the insertion hole due to the accidentally rotating of the rotating shaft 72 and the locking member 71, and further limit the lifting assembly 60 from lifting relative to the support assembly 50, thereby improving the stability of the locking assembly 70 in the locked state. When the insertion portion 711 is disengaged from the insertion hole, the second cam 74 rotates to a position with a smaller diameter toward the lifting assembly 60 and is separated from the lifting assembly 60, so that the rotation of the rotating shaft 72 and the locking member 71 and the lifting of the lifting assembly 60 relative to the support assembly 50 are not restricted.

Referring to FIGS. 6 to 7, the locking assembly 70 further includes a second handle 75 extending from the second cam 74 along a radical direction of the second cam 74. The user can drive the locking member 71 and the second cam 74 to rotate by controlling the second handle 75, so that the second handle 75 can facilitate the user to control and rotate the locking member 71 and the second cam 74, which is convenient and labor-saving.

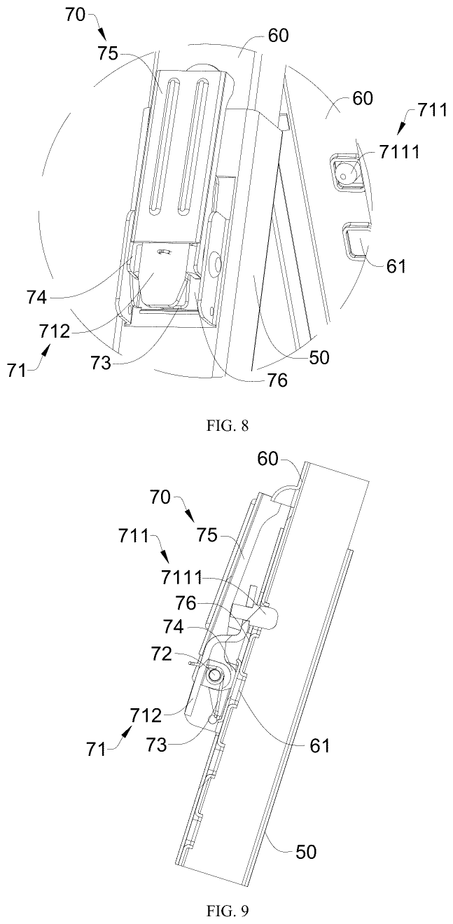

Referring to FIG. 8 to FIG. 9, the locking assembly 70 further includes a gasket 76 disposed on the support assembly 50, the gasket 76 is located between the second cam 74 and the lifting assembly 60, and the second cam 74 can abut against the lifting assembly 60 through the gasket 76. The gasket 76 can prevent the second cam 74 from directly contacting the lifting assembly 60, and prevent the rotation of the second cam 74 from causing wear to the lifting assembly 60, thereby protecting the lifting assembly 60.

Referring to FIG. 1, the present disclosure further provides a sawhorse, including the above-mentioned support and the above-mentioned support device, and the lifting assembly 60 is supported at the bottom of the fixed assembly 10. The sawhorse can stably clamp wood with different sizes via the support, thereby ensuring the stability of clamping the wood, ensuring the processing accuracy and processing efficiency, and reducing the processing cost of the wood. At the same time, the sawhorse can also adjust the height of the support through the support device, so that the support can adapt to different operation heights, and the support device can ensure the stability of the support and avoid the support shaking or tilting during the process of processing woods.

In the illustrated embodiment, the number of the support devices is four, and two of the four support devices form a group of support legs in a splayed shape. Two groups of splayed support legs are respectively arranged at two ends of the bottom of the support to ensure the stability of the support. Of course, in other embodiments, the number of the support devices may also be set to one, two, three or more, as long as the support can be stably supported and the height of the support can be adjusted as required, which is not specifically limited in the embodiments of the present disclosure.

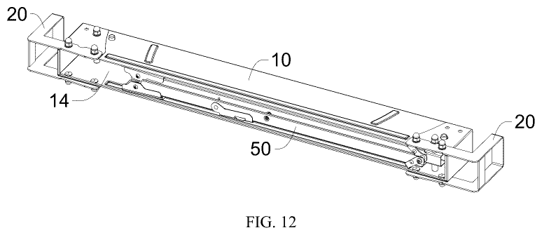

Referring to FIG. 1 and FIG. 12, the fixed assembly 10 is provided with an accommodating cavity 14 with an opening facing the supporting device, and the supporting device can rotate into the accommodating cavity 14 relative to the fixed assembly 10. The lifting assembly 60 of the support device is rotatably connected to the inner wall of the receiving cavity 14. When the sawhorse is not used, the user can rotate the support device relative to the support and receive the support device into the receiving cavity 14, thereby facilitating storage or transportation of the sawhorse.

The various technical features of the embodiments described above may be combined arbitrarily, and in order to make the description concise, all possible combinations of the various technical features in the embodiments described above are not described, however, as long as there is no contradiction between these combinations of technical features, they should be considered as the scope of the description.

The above embodiments only express several implementations of the present disclosure, and the description thereof is more specific and detailed, but it should not be construed as limiting the scope of the claims. It should be noted that a person of ordinary skill in the art may further make several variations and improvements without departing from the concept of the present disclosure, which all fall within the protection scope of the present disclosure. Therefore, the protection scope of the present disclosure shall be subject to the appended claims.

What is claimed is:

1. A support for fixing wood, comprising:
a fixed assembly;
a sliding assembly cooperating with the fixed assembly to clamp the wood, the sliding assembly being slidable relative to the fixed assembly to clamp wood of different sizes; and
a limiting assembly, disposed on the fixed assembly and/or the sliding assembly, and configured to lock or unlock sliding of the sliding assembly relative to the fixed assembly.

2. The support of claim 1, wherein the sliding assembly comprises a sliding member and a clamping member arranged at one end of the sliding member, and the fixed assembly is provided with a sliding groove;
one end of the sliding member away from the clamping member is capable of slidably extending into the sliding groove to adjust a distance between the clamping member and the fixed assembly when the sliding member slides relative to the fixed assembly.

3. The support of claim 2, wherein the limiting assembly comprises a limiting member, the sliding member is provided with a plurality of limiting holes arranged at intervals along a sliding direction of the sliding member, the fixed assembly is correspondingly provided with a through hole, and the limiting member is configured to pass through the through hole and any one of the plurality of limiting holes to lock sliding of the sliding assembly relative to the fixed assembly at different positions.

4. The support of claim 3, wherein the sliding member comprises a first sliding portion and a second sliding portion arranged at intervals along a penetrating direction of the limiting member, the first sliding portion is provided with an avoidance groove extending along a sliding direction of the sliding assembly, and the plurality of limiting holes are located on the second sliding portion; the limiting member is configured to sequentially pass through the avoidance hole and any one of the plurality of limiting holes from a side of the first sliding portion away from the second sliding portion.

5. The support of claim 4, wherein an abutting portion protrudes from an outer periphery of the limiting member, the limiting assembly further comprises an elastic member disposed between the abutting portion and a side wall of the sliding groove, and the elastic member is configured to apply an elastic force toward the limiting hole to the limiting member.

6. The support of claim 2, wherein the limiting assembly comprises a first cam arranged on the fixed assembly, and a side wall of the sliding groove corresponding to the first cam is provided with an avoidance hole;
the first cam is rotatable relative to the fixed assembly and is configured to push the sliding member at the avoidance hole, so that the sliding member abuts against a side wall of the sliding groove opposite to the avoidance hole.

7. The support of claim 6, wherein the limiting assembly further comprises a first handle extending from the first cam along a radial direction of the first cam.

8. The support of claim 1, further comprising a guide member disposed on one of the fixed assembly and the sliding assembly, wherein the other of the fixed assembly and the sliding assembly is provided with a guide groove extending along a sliding direction of the sliding assembly, and the guide member is slidably disposed in the guide groove.

9. A support device for supporting a support, comprising:
a support assembly;
a lifting assembly connected to the support and configured to lift relative to the support assembly along a length direction of the support assembly to drive the support to rise and fall; and
a locking assembly, disposed on the support assembly and/or the lifting assembly, and configured to lock or unlock lifting of the lifting assembly relative to the support assembly.

10. The support device of claim 9, wherein the locking assembly comprises a locking member arranged on one of the support assembly and the lifting assembly, and the other of the support assembly and the lifting assembly is provided with a plurality of locking elements arranged at intervals along a sliding direction of the lifting assembly;
the locking member can cooperate with any one of the plurality of locking elements to lock the sliding of the lifting assembly relative to the support assembly at different positions.

11. The support device of claim 10, wherein the locking member is pivotally connected to the support assembly and is rotatably inserted into or disengaged from the plurality of locking elements to lock or unlock lifting of the lifting assembly relative to the support assembly.

12. The support device of claim 11, wherein the locking assembly further comprises a rotating shaft and a torsion spring, the locking member is rotatable relative to the support assembly through the rotating shaft and two torsion arms of the torsion spring are respectively limited on the rotating shaft and the support assembly.

13. The support device of claim 11, wherein the locking member comprises an insertion portion configured to be inserted into the plurality of locking elements, and the plurality of locking elements is configured as insertion holes;
when the lifting assembly rises relative to the support assembly, an inner wall of the insertion hole is configured to push against the insertion portion, so that the insertion portion is disengaged from the insertion holes.

14. The support device of claim 13, wherein the insertion portion is configured as a protrusion or a hook.

15. The support device of claim 13, wherein the locking assembly further comprises a second cam disposed on the locking member and configured to rotate synchronously with the locking member and abut against the lifting assembly when the insertion portion is inserted into the insertion holes.

16. The support device of claim 15, wherein the locking assembly further comprises a second handle extending radially from the second cam.

17. The support device of claim 15, wherein the locking assembly further comprises a gasket disposed on the support assembly, the gasket is located between the second cam and the lifting assembly, and the second cam is capable of abutting against the lifting assembly through the gasket.

18. A sawhorse, comprising a support and a support device, wherein
the support is configured for fixing a wood, the support comprises:
a fixed assembly;
a sliding assembly cooperating with the fixed assembly to clamp the wood, the sliding assembly being slidable relative to the fixed assembly to clamp wood of different sizes; and
a limiting assembly, disposed on the fixed assembly and/or the sliding assembly, and configured to lock or unlock sliding of the sliding assembly relative to the fixed assembly;
the support device is configured for supporting the support, the support device comprises:
a support assembly;
a lifting assembly connected to the support and configured to lift relative to the support assembly along a length direction of the support assembly to drive the support to rise and fall; and
a locking assembly, disposed on the support assembly and/or the lifting assembly, and configured to lock or unlock lifting of the lifting assembly relative to the support assembly the lifting assembly is supported at a bottom of the fixed assembly.

19. The sawhorse of claim 18, wherein the fixed assembly is provided with an accommodating cavity with an opening facing the support device, and the support device is rotatable relative to the fixed assembly into the accommodating cavity.
